(19) United States
(12) Patent Application Publication
(10) Pub. No.: US 2012/0271513 A1
(43) Pub. Date: Oct. 25, 2012

(54) ELECTRIC POWER STEERING APPARATUS

(75) Inventors: Atsuhiko YONEDA, Utsunomiya-shi (JP); Yasuo SHIMIZU, Shimotsuke-shi (JP); Yoshihiro ONIWA, Utsunomiya-shi (JP); Yukihiro WAKAKUMA, Utsunomiya-shi (JP); Takashi MIYOSHI, Shioya-gun (JP)

(73) Assignee: HONDA MOTOR CO., LTD., Tokyo (JP)

(21) Appl. No.: 13/452,321

(22) Filed: Apr. 20, 2012

(30) Foreign Application Priority Data
Apr. 22, 2011 (JP) 2011-095801

(51) Int. Cl. B62D 6/10

(52) U.S. Cl. 701/41

(57) ABSTRACT

In the event of a failure of a first electric motor drive signal generator, e.g., the microcomputer, which generates a first electric motor drive signal for performing a feedback control, a second electric motor drive signal generator, e.g., a PWM signal generator, which is made up of discrete circuit components, directly converts a steering torque signal into a second electric motor drive signal. An electric motor, which generates the assistive steering force, is driven by the second electric motor drive signal.

### CROSS-REFERENCE TO RELATED APPLICATION

This application is based upon and claims the benefit of priority from Japanese Patent Application No. 2011-095801 filed on Apr. 22, 2011, of which the contents are incorporated herein by reference.

### BACKGROUND OF THE INVENTION

1. Field of the Invention

The present invention relates to an electric power steering apparatus for transmitting power from an electric motor, which serves as an assistive steering force (steering assisting force), to a vehicle steering system in order to reduce the burden on a driver of a vehicle who operates a steering member such as a steering wheel when the driver turns the steering member to steer the vehicle.

2. Description of the Related Art

Recent years have seen widespread use of electric power steering apparatus, which detect a steering torque generated by the steering wheel of a vehicle with a steering torque sensor and energize an electric motor to generate an assistive steering force depending on the detected steering torque, in order to allow the driver of the vehicle to turn the vehicle by applying a light steering force to the steering wheel.

FIG. 17 of the accompanying drawings shows a configuration of a known electric power steering apparatus 1000, in which a microcomputer 1008 generates a PWM (pulse width modulation) signal.

As shown in FIG. 17, the electric power steering apparatus 1000 includes an electric motor 1002 for applying an assistive steering force to the vehicle steering system, a steering torque sensor 1004 for detecting a steering torque generated by the vehicle steering system, a vehicle speed sensor 1006 for detecting the speed of the vehicle, a microcomputer 1008 for generating a PWM signal as an electric motor control signal Vo based on a steering torque signal Ts from the steering torque sensor 1004 and a vehicle speed signal Vs from the vehicle speed sensor 1006, an electric motor driver 1010 for energizing the electric motor 1002 based on the electric motor control signal Vo, and a current sensor (electric motor current detector) 1012 for detecting an electric motor current Im that flows to the electric motor 1002.

The microcomputer 1008 has a data processing capability for processing at least 16 bits at a time. The microcomputer 1008 performs various functions, and includes a target current setting section 1014 for determining a target current signal Ims representative of a target value for the electric motor current Im based on the steering torque signal Ts and the vehicle speed signal Vs, a difference calculator 1016 for calculating a difference between the target current signal Ims and an electric motor current signal Imo from the current sensor 1012 and outputting a difference signal ΔI indicative of the calculated difference, a PID compensator 1018 for performing a proportional (P) plus integral (I) plus derivative (D) compensation on the difference signal ΔI, and a PWM signal generator 1020 for generating a PWM signal as an electric motor control signal Vo based on an output signal Ipid from the PID compensator 1018. The microcomputer 1008 is configured to serve as various calculating means (calculators), memory means (memories), and processing means (processors), on the basis of a microprocessor.

The target current setting section 1014 has a memory such as a ROM or the like, which stores associated data of the steering torque signal Ts and the target current signal Ims, with the vehicle speed signal Vs serving as a parameter. The target current setting section 1014 reads the target current signal Ims from the stored data based on the steering torque signal Ts from the steering torque sensor 1004 and the vehicle speed signal Vs from the vehicle speed sensor 1006, and outputs the read target current signal Ims to the difference calculator 1016.

The difference calculator 1016, which has a subtracting capability, calculates the difference between the target current signal Ims and the electric motor current signal Imo from the current sensor 1012, and outputs a difference signal ΔI indicative of the calculated difference to the PID compensator 1018.

The PID compensator 1018 includes a proportional element (P), an integral element (I), and a derivative element (D). The PID compensator 1018 performs a proportional (P) plus integral (I) plus derivative (D) compensation on the difference signal ΔI, and produces an output signal Ipid as a result.

The PWM signal generator 1020 generates a PWM signal as an electric motor control signal Vo based on the output signal Ipid from the PID compensator 1018. The PWM signal generator 1020 outputs the electric motor control signal Vo to the electric motor driver 1010 for controlling the electric motor driver 1010 under a PWM control in order to converge the difference signal ΔI quickly to nil.

Based on the electric motor control signal Vo, the electric motor driver 1010 energizes and controls the electric motor 1002 under the PWM control with an electric motor drive voltage Vm. The electric motor driver 1010 has a bridge circuit of switching elements such as power FETs (field effect transistors), for example. The power FETs are energized by the electric motor control signal Vo from the PWM signal generator 1020, so as to establish a magnitude and direction of the electric motor current Im based on the electric motor drive voltage Vm that is applied to the electric motor 1002.

The current sensor 1012, which is in the form of a differential amplifier or the like, differentially amplifies a voltage drop caused across a current detecting component, e.g., a resistor, which is connected in series with the electric motor 1002, by the electric motor current Im that flows through the current detecting component. The current sensor 1012 converts the amplified voltage drop into a signal level corresponding to the target current signal Ims, and outputs the signal level as an electric motor current signal Imo to the difference calculator 1016.

More specifically, the current sensor 1012 converts the electric motor current Im detected by the current detecting component into an electric motor current signal Imo, and supplies the electric motor current signal Imo as a feedback signal to the microcomputer 1008. In this manner, the electric power steering apparatus 1000 provides a closed feedback loop in an electric motor current control system.

Since as described above, the microcomputer 1008 of the conventional electric power steering apparatus 1000 has a data processing capability for processing at least 16 bits at a time, the electric power steering apparatus 1000 is capable of performing a sophisticated feedback control process for accurately diagnosing failures of the sensors including the steering torque sensor 1004, the vehicle speed sensor 1006, and the current sensor 1012, as well as for diagnosing failures of the electric motor 1002 and the electric motor driver 1010, in order to carry out a quick fail-safe process.

A power supply circuit (not shown) performs a watchdog timer monitoring process on the microcomputer 1008. Another microcomputer (not shown), which differs from the microcomputer 1008, is added for performing a failure diagnosing function in order to detect failures of the microcomputer 1008.

In the event of a failure of the microcomputer 1008, which is detected by the failure diagnosing function of the other microcomputer, the fail-safe process stops generating the electric motor control signal Vo from the microcomputer 1008, and turns off a fail-safe relay and a power relay (not shown), so as to prevent unwanted motor power from being transmitted to the vehicle steering system.

However, if the electric power steering apparatus 1000 becomes fully inoperative upon failure of the microcomputer 1008, then the user, such as a driver of the vehicle incorporating the electric power steering apparatus 1000, must drive the vehicle to a car dealer or the like with the broken electric power steering apparatus 1000 in order for repairs to be carried out thereon. However, even though this task is temporary, the user may find the task rather awkward and troublesome to perform.

Japanese Laid-Open Patent Publication No. 2009-067077 discloses a steering apparatus with a redundant system, which includes a first motor drive means having a microcomputer, a second motor drive means (redundant system), which is free of a microcomputer, for use in emergency, and a power relay for selectively supplying output signals to an electric motor from the first and second motor drive means.

According to the steering apparatus disclosed in Japanese Laid-Open Patent Publication No. 2009-067077, in the event of a failure of the microcomputer of the first motor drive means, the power relay is actuated to switch to the second motor drive means, whereupon the second motor drive means is operated to energize the electric motor, which applies an assistive steering force to the vehicle steering system of the steering apparatus.

### SUMMARY OF THE INVENTION

The second motor drive means disclosed in Japanese Laid-Open Patent Publication No. 2009-067077 detects only the direction in which a steering wheel is turned, and applies a DC battery voltage to the electric motor, the polarity of which corresponds to the detected direction, for enabling the electric motor to generate an assistive steering force. Therefore, the disclosed second motor drive means is low in performance and has much to be improved. In addition, changing the polarity of the DC voltage requires a large-capacity power relay for switching between large electric currents each time that the steering wheel is turned. Such a large-capacity power relay results in an increased space required for installation of the redundant electric power steering mechanism.

It is an object of the present invention to provide an electric power steering apparatus, which is of a simple, small, and highly reliable configuration, for applying an assistive steering force depending on a steering torque to a vehicle steering system, even in the event of a failure of a first electric motor drive signal generator that belongs to the main system.

According to the present invention, there is provided an electric power steering apparatus comprising an electric motor for applying an assistive steering force to a steering system, a steering torque sensor for detecting a steering torque of the steering system, a torque sensor circuit for generating a steering torque signal based on the torque detected by the steering torque sensor, a first electric motor drive signal generator for generating a first electric motor drive signal based on the steering torque signal, an electric motor driver for driving the electric motor based on the first electric motor drive signal, and a second electric motor drive signal generator for directly converting the steering torque signal generated by the torque sensor circuit into a second electric motor drive signal, which changes depending on the magnitude of the steering torque signal. In the event of a failure of the first electric motor drive signal generator, the electric motor driver drives the electric motor based on the second electric motor drive signal, which is generated by the second electric motor drive signal generator.

According to the present invention, in the event of a failure of the first electric motor drive signal generator, which belongs to the main system, the electric motor driver drives the electric motor based on the second electric motor drive signal, which is generated by the second electric motor drive signal generator and which belongs to a redundant system. The second electric motor drive signal generator directly converts the steering torque signal generated by the torque sensor circuit into the second electric motor drive signal, which changes depending on the magnitude of the steering torque signal. Therefore, even in the event of a failure of the first electric motor drive signal generator, which belongs to the main system, it is still possible for an assistive steering force to be applied to the steering system depending on the steering torque, by means of a simple, small, and highly reliable arrangement, i.e., a less failure-prone arrangement, using the second electric motor drive signal generator that belongs to the simpler redundant system.

The second electric motor drive signal generator may directly convert the steering torque signal generated by the torque sensor circuit into a second electric motor drive signal, which changes depending on the magnitude of the steering torque signal, irrespective of a target current supplied to the electric motor.

Since the second electric motor drive signal generator generates the second electric motor drive signal without calculating a target current based on the magnitude of the steering torque signal, the second electric motor drive signal generator is simpler in arrangement, has a low failure rate, and is highly reliable.

The first electric motor drive signal generator may generate the first electric motor drive signal for enabling the electric motor driver to drive the electric motor under a feedback control based on the steering torque signal. The second electric motor drive signal generator may generate the second electric motor drive signal, which changes depending on the magnitude of the steering torque signal, for enabling the electric motor driver to drive the electric motor under a feed-forward control.

In the event of a failure of the first electric motor drive signal generator, which carries out a feedback control, the electric motor driver drives the electric motor based on the second electric motor drive signal generated by the second electric motor drive signal generator, which carries out a feed-forward control. Therefore, the second electric motor drive signal generator, which belongs to the redundant system, is simple, small, and highly reliable.

The first electric motor drive signal generator may include a microcomputer, and the second electric motor drive signal generator may comprise circuit components apart from a microcomputer. The circuit components may be discrete components, for example, including any one of resistors, transistors, etc., analog ICs including operational amplifiers, etc., digital ICs including multiplexers, logic circuits, etc. Alternatively, the second electric motor drive signal generator may comprise an integrated circuit including the aforementioned circuit components. Since the second electric motor drive signal generator includes a much smaller number of circuit components than a microcomputer, the second electric motor drive signal generator has a low failure rate and is highly reliable.

The first electric motor drive signal generator and the second electric motor drive signal generator may comprise a first microcomputer and a second microcomputer, respectively, and the second microcomputer may have a data processing capability for processing a smaller number of bits per unit time than the first microcomputer. Therefore, the second microcomputer generates less heat, has a lower failure rate, and is more reliable than the first microcomputer.

The first electric motor drive signal generator may generate the first electric motor drive signal based on a vehicle speed signal in addition to the steering torque signal, and the second electric motor drive signal generator may generate the second electric motor drive signal based only on the steering torque signal. Thus, the second electric motor drive signal generator is simple in arrangement and is highly reliable.

The torque sensor circuit may include a plurality of torque sensor circuits, and in the event of a failure of one of the torque sensor circuits, the remaining torque sensor circuits may be used to detect a steering torque of the steering system. Thus, the entire torque sensor circuit is highly reliable. The torque sensor circuit is capable of detecting when wires, which connect the steering torque sensor to the torque sensor circuit, are broken. The torque sensor circuits may be of a single circuit configuration, or may comprise different circuit configurations.

The second electric motor drive signal generator is capable of operating prior to the first electric motor drive signal generator suffering a failure. When the first electric motor drive signal generator suffers a failure, the first electric motor drive signal may instantaneously switch to the second electric motor drive signal, which is generated by the second electric motor drive signal generator. Accordingly, no delay occurs when the first electric motor drive signal switches to the second electric motor drive signal, thereby allowing the electric power steering apparatus to operate smoothly and continuously upon switching from the first electric motor drive signal to the second electric motor drive signal.

Each of the first electric motor drive signal and the second electric motor drive signal preferably comprises a PWM signal. Such a PWM signal may easily be generated by a microcomputer or a circuit made up of discrete components.

The steering torque sensor may comprise a magnetostrictive torque sensor for detecting the steering torque of the steering system based on a change in the magnetic permeability thereof. In such a case, the steering torque sensor is constructed of a small number of parts having a small-scale structure. Even if a microcomputer-based control process performed by the electric power steering apparatus is stopped, thereby disabling a control process such as an inertia correction control process, which improves feeling during driving, the torsional rigidity between the steering wheel of the steering system and the electric motor, which has a large moment of inertia, is increased, a delay in steering action is reduced, and a favorable steering sensation is maintained.

According to the present invention, in the event of a failure of the first electric motor drive signal generator, which belongs to the main system, the electric motor driver continues to drive the electric motor based on the second electric motor drive signal, which is generated by the second electric motor drive signal generator belonging to the redundant system, and which directly converts the steering torque signal generated by the torque sensor circuit into the second electric motor drive signal that changes depending on the magnitude of the steering torque signal. Therefore, even in the event of a failure of the first electric motor drive signal generator belonging to the main system, it is possible to apply an assistive steering force depending on the steering torque to the steering system with a simple, small, and highly reliable arrangement, i.e., a less failure-prone arrangement, using the second electric motor drive signal generator belonging to the simpler redundant system.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view, partially in block form, of an electric power steering apparatus according to a first embodiment of the present invention;

FIG. 2 is a block diagram of a circuit arrangement of the electric power steering apparatus according to the first embodiment;

FIG. 3 is a circuit diagram, partially in block form, of a torque sensor circuit of the electric power steering apparatus;

FIG. 4A is a diagram showing detected voltages corresponding to steering torques, which are generated by a signal generator in a main system;

FIG. 4B is a diagram showing detected voltages corresponding to steering torques, which are generated by a signal generator in a redundant system;

FIG. 5 is a block diagram of a PWM signal generator made up of discrete components;

FIG. 6A is a diagram showing a characteristic curve of an output signal from a low-pass filter, which corresponds to a torque signal;

FIG. 6B is a diagram showing a characteristic curve of an output signal from a polygonal curve circuit, which corresponds to an output signal from the low-pass filter;

FIG. 6C is a diagram showing a characteristic curve of a PWM duty ratio, which corresponds to an output signal from the low-pass filter;

FIG. 7 is a diagram showing a PWM signal generated by the PWM signal generator shown in FIG. 5;

FIG. 8 is a block diagram of another PWM signal generator made up of discrete components;

FIG. 9A is a diagram showing a characteristic curve of an output signal from a low-pass filter, which corresponds to a torque signal;

FIG. 9B is a diagram showing the characteristic curve of an output signal from an absolute value circuit, which corresponds to an output signal from the low-pass filter;

FIG. 9C is a diagram showing a characteristic curve of an output signal from a polygonal curve circuit, which corresponds to an output signal from the low-pass filter;

FIG. 9D is a diagram showing a characteristic curve of a PWM duty ratio, which corresponds to an output signal from the low-pass filter;

FIG. 9E is a diagram showing a characteristic curve of a left/right judging signal, which corresponds to an output signal from the low-pass filter;

FIG. 10 is a diagram showing a PWM signal generated by the PWM signal generator shown in FIG. 8;

FIG. 11 is a block diagram showing a functional configuration for performing functions of the electric power steering apparatus according to the first embodiment, with the microcomputer shown in FIG. 2;

FIG. 12A is a diagram showing energization of an FET bridge when a steering wheel is assisted to turn to the right;

FIG. 12B is a diagram showing energization of the FET bridge when the steering wheel is assisted to turn to the left;

FIG. 13 is a timing chart illustrative of switching between PWM signals in the event of a failure of the microcomputer;

FIG. 14 is a schematic view, partially in block form, of an electric power steering apparatus according to a second embodiment of the present invention;

FIG. 15 is a block diagram of a circuit arrangement of the electric power steering apparatus according to the second embodiment;

FIG. 16 is a block diagram of a circuit arrangement of an electric power steering apparatus according to a third embodiment of the present invention; and

FIG. 17 is a block diagram of a circuit arrangement of a general electric power steering apparatus, in which a microcomputer generates a PWM signal.

### DESCRIPTION OF THE PREFERRED EMBODIMENTS

Electric power steering apparatus according to preferred embodiments of the present invention will be described in detail below with reference to the accompanying drawings.

### 1st Embodiment

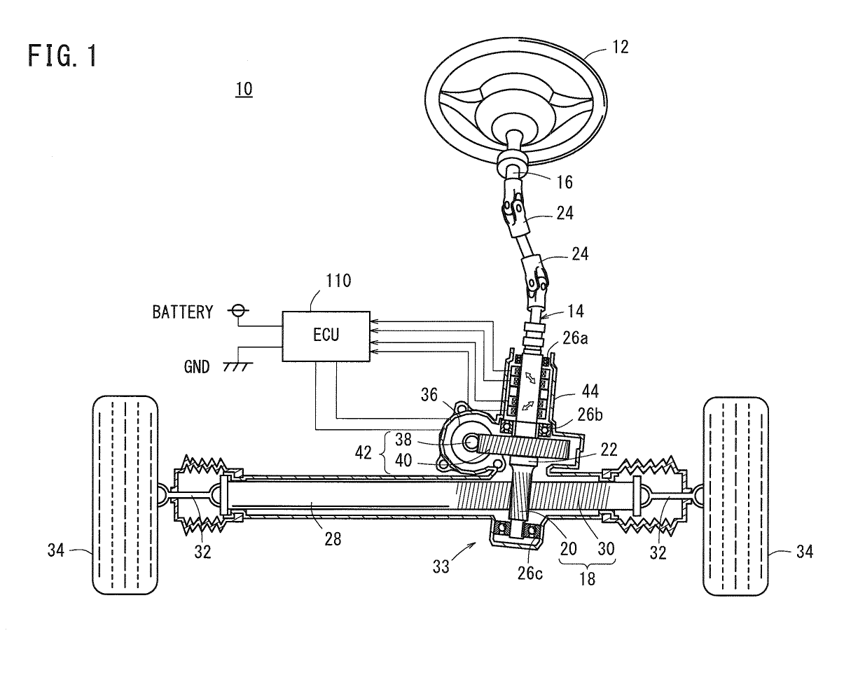

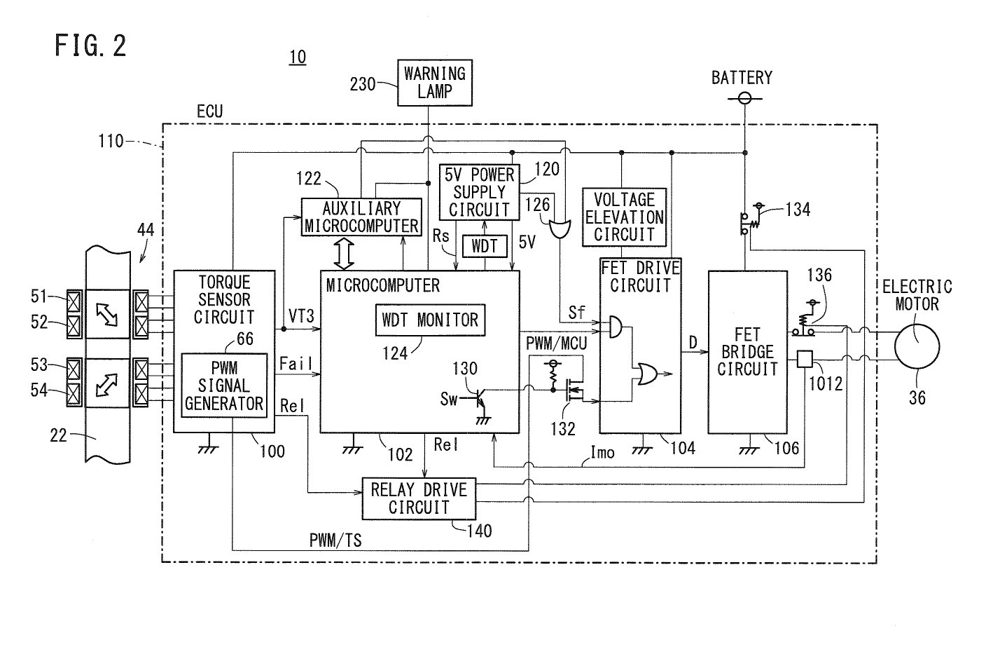

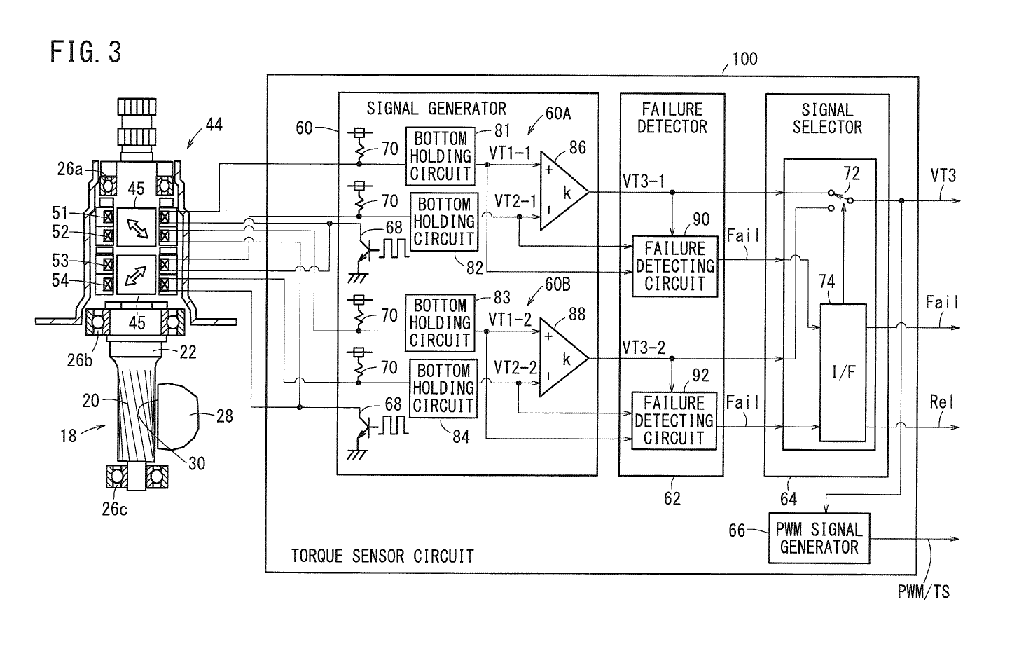

FIG. 1 schematically shows, partially in block form, an electric power steering apparatus (EPS) 10 according to a first embodiment of the present invention. FIG. 2 shows in block form a circuit arrangement of the electric power steering apparatus 10 according to the first embodiment. FIG. 3 shows in block form a torque sensor circuit 100 of the electric power steering apparatus 10.

As shown in FIG. 1, the electric power steering apparatus 10, which is incorporated in a vehicle, includes a steering shaft assembly 14 coupled to a steering wheel 12, which serves as a steering member. The steering shaft assembly 14 includes a main steering shaft 16 integrally connected to the steering wheel 12, and a pinion shaft 22 having a pinion gear 20 of a rack and pinion mechanism 18. The main steering shaft 16 and the pinion shaft 22 are coupled to each other by a pair of universal joints 24.

The pinion shaft 22 has an upper portion, an intermediate portion, and a lower portion, which are supported respectively by bearings 26a, 26b, 26c. The pinion gear 20 is disposed on a lower end portion of the pinion shaft 22. The pinion gear 20 is held in mesh with rack teeth 30 of a rack bar 28, which is movable axially back and forth in transverse directions of the vehicle. The rack bar 28 has opposite ends coupled by respective tie rods 32 to left and right road wheels 34, which function as steerable wheels of the vehicle.

When the driver of the vehicle turns the steering wheel 12, the steering wheel 12 causes the steering shaft assembly 14 to turn the front wheels 34 through the rack and pinion mechanism 18, thereby steering the vehicle. The rack bar 28, the rack teeth 30, and the tie rods 32 jointly make up a steering mechanism 33.

The steering mechanism 33, the steering shaft assembly 14 (i.e., the main steering shaft 16 and the pinion shaft 22, which are connected to each other by the universal joints 24), and the steering wheel 12 jointly make up a vehicle steering system.

The electric power steering apparatus 10 also includes an electric motor 36 for supplying an assistive steering force to the pinion shaft 22, for thereby reducing the manual steering force that the driver applies to the steering wheel 12. The electric motor 36 has an output shaft supporting a worm gear 38, which is held in driving meshed engagement with a worm wheel 40. The worm wheel 40 is mounted on the pinion shaft 22 beneath the intermediate bearing 26b. The worm gear 38 and the worm wheel 40 jointly make up a speed reducer mechanism 42, which functions to smoothly convert the rotational drive power of the electric motor 36 into a boosted rotational drive power of the pinion shaft 22.

A magnetostrictive torque sensor (steering torque sensor) 44 for detecting a torque applied to the pinion shaft 22, i.e., the steering shaft assembly 14, based on a change in magnetic properties due to magnetostriction is mounted on the pinion shaft 22 between the intermediate bearing 26b and the upper bearing 26a.

As shown in FIGS. 1 through 3, the magnetostrictive torque sensor 44 comprises two upper and lower magnetostrictive films 45 (see FIG. 3) mounted on the surface of the pinion shaft 22. Each of the magnetostrictive films 45 is in the form of a plated film made up of Ni (65%) and Fe (35%) having a thickness of about 40 μm, and having a prescribed width along the axis of the pinion shaft 22. The magnetostrictive films 45 exhibit given respective magnetic anisotropic properties oriented in respective opposite directions.

More specifically, the magnetostrictive films 45 exhibit respective magnetic anisotropic properties in the following manner. While a prescribed torque of 10 kgm is applied in one direction to the pinion shaft 22, the upper magnetostrictive film 45 (Ni—Fe plating) is heated by high-frequency induction heating to about 300° C. below the Curie point, and then the upper magnetostrictive film 45 is cooled. After the upper magnetostrictive film 45 has cooled, torque is removed from the pinion shaft 22, thereby imparting a magnetic anisotropy to the upper magnetostrictive film 45. Similarly, while a prescribed torque of 10 kgm is being applied in the opposite direction to the pinion shaft 22, the lower magnetostrictive film 45 is heated by high-frequency induction heating to about 300° C. below the Curie point, and then the lower magnetostrictive film 45 is cooled. After the lower magnetostrictive film 45 has cooled, torque is removed from the pinion shaft 22, thereby imparting a magnetic anisotropy to the lower magnetostrictive film 45. When a steering torque is applied respectively to the magnetostrictive films 45 from the pinion shaft 22, the magnetostrictive films 45 exhibit inverse magnetostrictive properties based on the magnetic anisotropic properties thereof, and such inverse magnetostrictive properties are detected based on AC resistances, etc., of four coils 51, 52, 53, 54, which are disposed around the magnetostrictive films 45, thereby detecting the steering torque.

The four coils 51, 52, 53, 54 are electrically connected by wires to a torque sensor circuit 100. As shown in FIG. 2, the torque sensor circuit 100 is included as part of an ECU (electronic control unit) 110. As shown in FIG. 3, the torque sensor circuit 100 comprises a signal generator 60, a failure detector 62, a signal selector 64, and a PWM signal generator 66. As described later, the torque sensor circuit 100 generates torque detection voltages VT3-1 and VT3-2, respectively, for a main system and a redundant system. The torque detection voltages VT3-1 and VT3-2 serve collectively as one steering torque signal VT3.

The signal generator 60 is connected to the four coils 51, 52, 53, 54, which will be referred to respectively as a first coil 51, a second coil 52, a third coil 53, and a fourth coil 54, and which are spaced successively from the steering wheel 12 on a side opposite from the pinion gear 20.

The first and third coils 51, 53 have respective ends, the voltage of which is pulled up to 5 V by respective pull-up resistors 70, and respective other ends, which are connected respectively to open-collector switching transistors 68. The switching transistors 68 are energized by a rectangular-wave signal having a frequency ranging from 13 to 14 kHz, and the switching transistors 68 are short-circuited to ground, for thereby passing alternating currents through the first and third coils 51, 53.

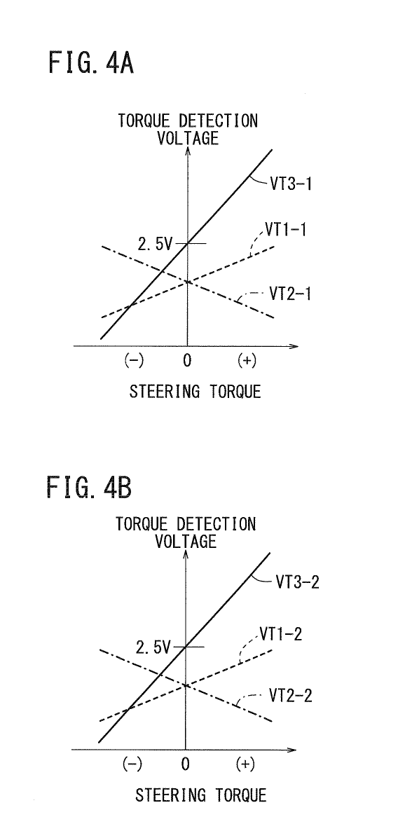

At this time, voltages between the first and third coils 51, 53 and the respective pull-up resistors 70 exhibit a transient response. The lowest values of the voltages are held by bottom holding circuits 81, 82 of a signal generator section 60A of the main system. Accordingly, the bottom holding circuits 81, 82 generate respective voltages VT1-1 and VT2-1, as shown in FIG. 4A.

The signal generator section 60A of the main system includes an amplifier circuit 86, which calculates a voltage VT3-1 (see FIG. 4A) from the voltages VT1-1, VT2-1 according to the following equation (1):

VT3-1=k{(VT1-1)−(VT2-1)}+2.5 [V] (1)

Similarly, the second and fourth coils 52, 54 are connected to respective pull-up resistors 70 and to respective open-collector switching transistors 68. The second and fourth coils 52, 54 also are connected respectively to bottom holding circuits 83, 84 of a signal generator section 60B of the redundant system. The bottom holding circuits 83, 84 generate voltages VT1-2, VT2-2, respectively, as shown in FIG. 4B, which are applied to an amplifier circuit 88 that calculates a voltage VT3-2 (see FIG. 4B) from the voltages VT1-2, VT2-2 according to the following equation (2):

VT3-2=k{(VT1-2)−(VT2-2)}+2.5 [V] (2)

Each of the bottom holding circuits 81, 82, 83, 84 may comprise a comparator and an RC circuit.

The voltages VT3-1, VT3-2 serve collectively as one steering torque signal VT3. Therefore, the torque sensor circuit 100 may be regarded as having a plurality of torque sensor circuits, each of which may have the same circuit configuration, or have different circuit configurations respectively.

The failure detector 62 includes a failure detecting circuit 90 of the main system, as well as a failure detecting circuit 92 of the redundant system. The failure detecting circuits 90, 92 calculate respective voltage values according to the following formulas (3) and (4):

(VT1-1)+(VT2-1) (3)

(VT1-2)+(VT2-2) (4)

The voltage values calculated according to formulas (3) and (4) are substantially constant when the magnetostrictive torque sensor 44 is normal. If the value of (VT1-1)+(VT2-1) falls outside of a predetermined range, then the failure detecting circuit 90 decides that the magnetostrictive torque sensor 44 is suffering a failure. Similarly, if the value of (VT1-2)+(VT2-2) falls outside of a predetermined range, then the failure detecting circuit 92 decides that the magnetostrictive torque sensor 44 is suffering a failure.

Furthermore, the failure detecting circuits 90, 92 compare the values of the voltages VT3-1, VT3-2 calculated by the amplifier circuits 86, 88 with the voltage values calculated by the failure detecting circuits 90, 92 in order to diagnose whether a failure has occurred in the amplifier circuits 86, 88.

If the failure detecting circuits 90, 92 detect a failure, then the failure detecting circuits 90, 92 output respective failure detection signals (Fail), which may be of a level 0 when normal and a level 1 in the event of a failure, for example. Such failure detection signals are output to an interface (I/F) circuit 74 of the signal selector 64.

Each of the failure detecting circuits 90, 92 may comprise an adder-subtractor, a multiplier, and a comparator.

The signal selector 64 includes a multiplexer 72 in addition to the interface circuit 74. When none of the failure detection signals (Fail) are supplied to the interface circuit 74, the interface circuit 74 operates the multiplexer 72 to output the voltage VT3-1 as the torque signal VT3. When either one of the failure detection signals (Fail) is supplied to the interface circuit 74, the interface circuit 74 operates the multiplexer 72 to output one of the voltages VT3-1, VT3-2, which is not associated with the supplied failure detection signal (Fail), as the torque signal VT3. The interface circuit 74 also outputs the supplied failure detection signal (Fail) to a microcomputer 102 (see FIG. 2), and outputs a relay signal (Rel) to a relay drive circuit 140 (see FIG. 2). Each of the failure detection signals (Fail) is a 2-bit signal, for example, which distinguishes between normal and failure states, as well as between the main system and the redundant system.

The signal generator 60, the failure detector 62, the signal selector 64, and the PWM signal generator 66 of the torque sensor circuit 100, details of which will be described later, may be constructed of discrete circuits, i.e., discrete components, and integrated circuits, such components including resistors, transistors, etc., analog ICs including operational amplifiers, etc., digital ICs including multiplexers, logic circuits, etc. The number of such components is much smaller than the number of components used in microcomputers. Therefore, the torque sensor circuit 100 is highly reliable. The torque sensor circuit 100, which is low in cost and highly reliable, may alternatively be in the form of a microcomputer having a data processing capability for processing a maximum of 8 bits at a time.

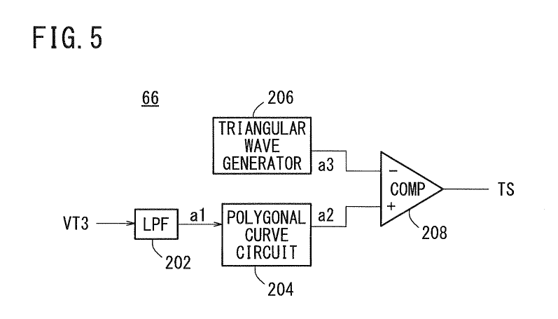

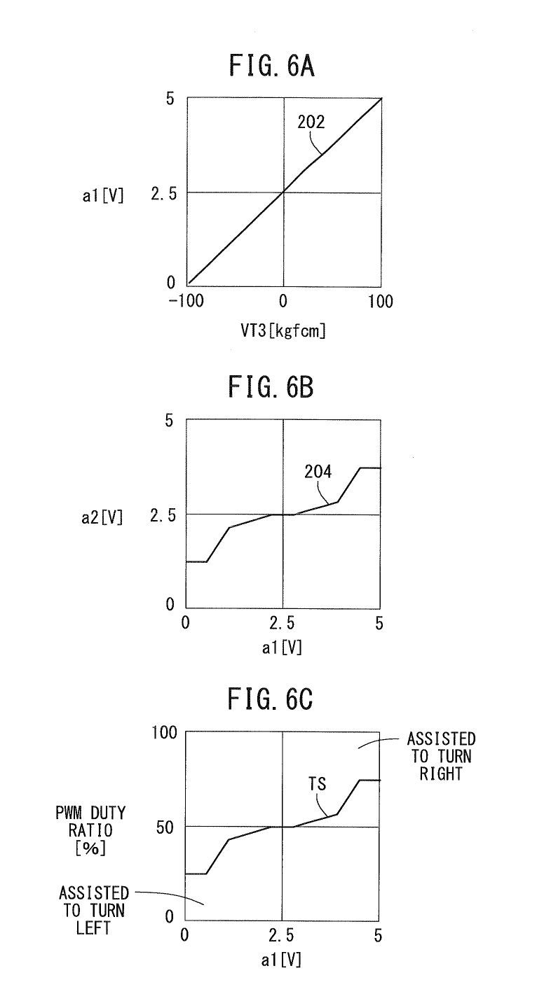

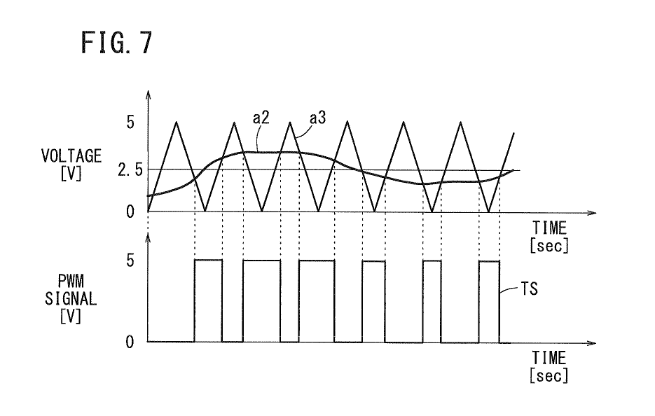

FIG. 5 shows in block form details of the PWM signal generator 66 in the form of an analog circuit. As shown in FIG. 5, the PWM signal generator 66 includes an LPF (low pass filter) 202 made up of a resistor and a capacitor for cutting off high-frequency noise of the torque signal VT3, a polygonal curve circuit 204 made up of an OP amplifier, a resistor, and a diode for converting a signal a1 (see FIG. 6A), which represents the torque signal VT3 after noise has been removed therefrom, into a signal a2 (see FIG. 6B) depending on the torque signal VT3 (steering torque [kgfcm]), and a comparator 208 for comparing the signal a2 (see FIG. 7) as a polygonal curve output signal with a triangular wave signal a3 (see FIG. 7) generated by a triangular wave generator 206, and for outputting a PWM signal TS (see FIG. 7). FIG. 6C shows the relationship between the signal a1 and the duty ratio of the PWM signal TS (PWM duty ratio [%]) generated as the result of comparison from the comparator 208.

The signal a2 from 0 to 2.5 to 5 [V] as a polygonal curve output signal corresponds to the range of steering torques from −100 to 0 to 100 [kgfcm], as shown in FIG. 6C, and the signal a2 corresponds to the range of PWM duty ratios from 0 to 50 to 100 [%] of the PWM signal TS.

Accordingly, the PWM signal generator 66 that generates the PWM signal TS can simply be configured by a small number of circuit elements.

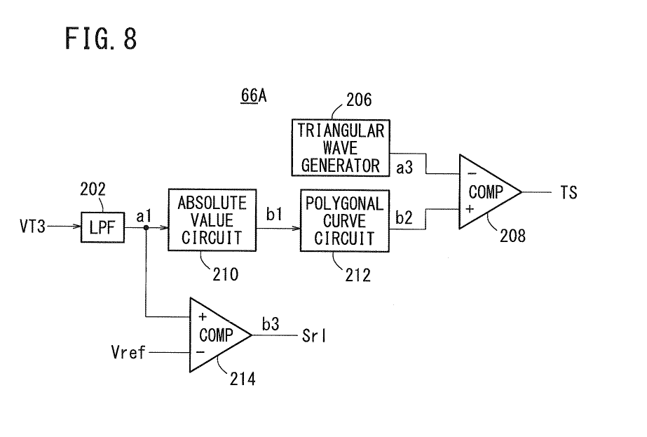

FIG. 8 shows in block form another PWM signal generator 66A in the form of an analog circuit. The PWM signal generator 66A outputs a PWM signal TS as well as a left/right judging signal Sr1.

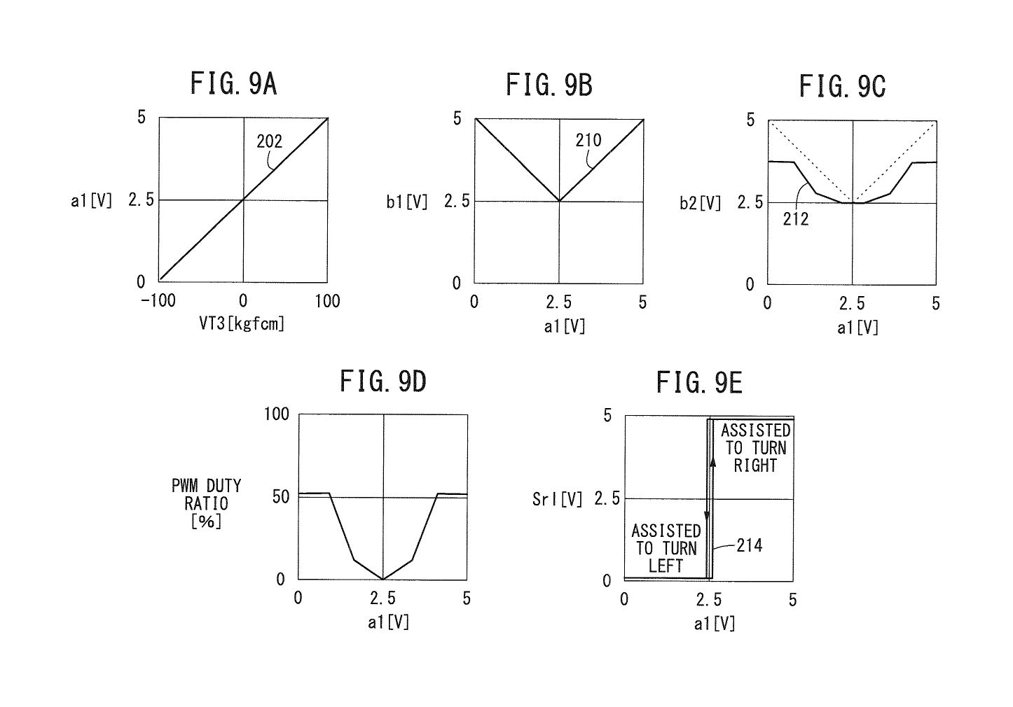

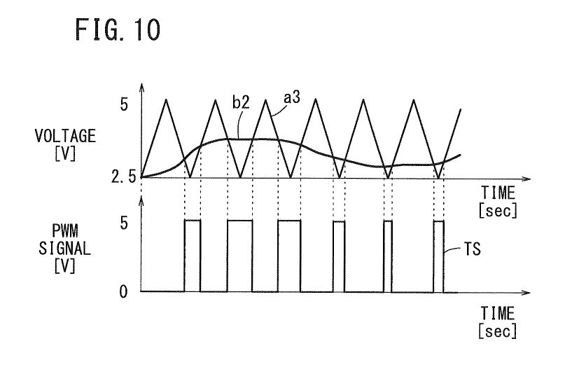

As shown in FIG. 8, the PWM signal generator 66A includes an LPF 202 made up of a resistor and a capacitor for blocking high-frequency noise of the torque signal VT3, an absolute value circuit 210 made up of an OP amplifier, a resistor, and a diode for outputting a signal b1 (see FIG. 9B) as the absolute value of the signal a1 (see FIG. 9A, which is identical to FIG. 6A), which represents the torque signal VT3 after noise has been removed therefrom, a polygonal curve circuit 212 (see FIG. 9C) made up of an OP amplifier, a resistor, and a diode for converting the signal b1 into a signal b2 (see FIG. 10) as a polygonal curve signal, a comparator 208 for comparing the signal b2 (see FIG. 10) as a polygonal curve output signal with a triangular wave signal a3 (see FIG. 10) generated by a triangular wave generator 206 and for outputting a PWM signal TS (see FIG. 10), and a judging circuit 214 (comparator circuit) for comparing the signal a1 with a reference voltage Vref (=2.5 [V]) and outputting a left/right judging signal Sr1, which is of 5 [V]=1 (high level) when the steering wheel 12 is assisted to turn to the right (see FIG. 9E), and of 0 [V]=0 (low level) when the steering wheel 12 is assisted to turn to the left (see FIG. 9E).

FIG. 9D shows the relationship between the signal a1 and the duty ratio of the PWM signal TS (PWM duty ratio [%]), which is generated as the result of the comparison by the comparator 208.

Since the PWM signal generators 66, 66A are of a simple configuration, the PWM signal generators 66, 66A may be in the form of a microcomputer having a data processing capability for processing a maximum of 8 bits at a time.

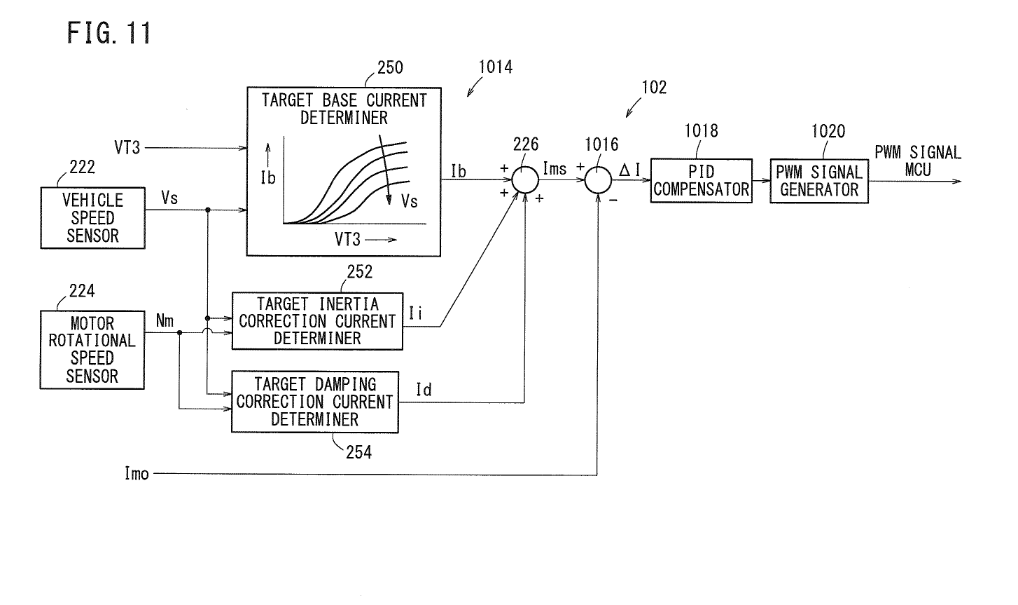

The microcomputer 102 shown in FIG. 2 is a high-performance microcomputer having a data processing capability for processing at least 16 bits or 32 bits at a time. FIG. 11 shows in block form a functional configuration for performing functions of the electric power steering apparatus according to the first embodiment, when the microcomputer 102 shown in FIG. 2 executes programs.

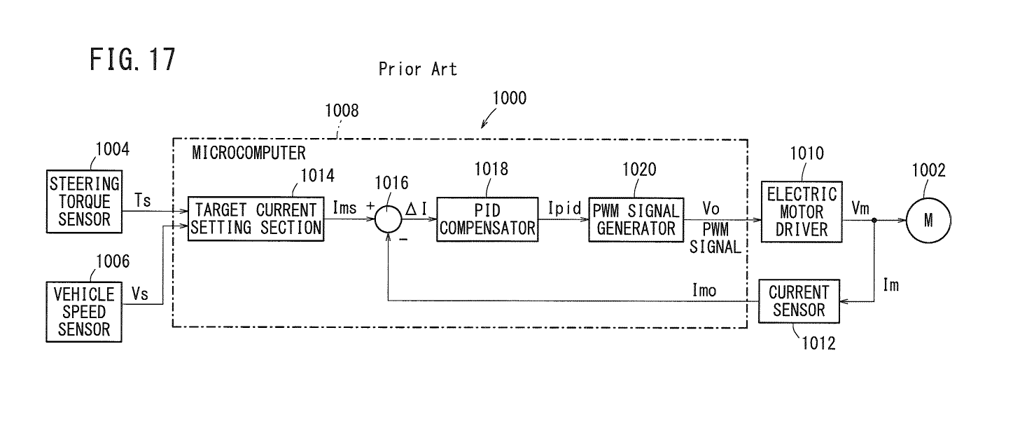

As shown in FIG. 11, as functions of the electric power steering apparatus, the microcomputer 102 includes a target current setting section 1014, a difference calculator 1016, a PID compensator 1018, and a PWM signal generator 1020, which correspond to the functions performed by the microcomputer 1008 shown in FIG. 17.

The microcomputer 102 is supplied with the torque sensor failure signal (Fail) and the torque signal VT3 from the torque sensor circuit 100, a vehicle speed signal Vs from a vehicle speed sensor 222, and a motor rotational speed signal Nm from a motor rotational speed sensor 224. The microcomputer 102 filters and processes the supplied signals and determines a target current (target motor current) Ims.

A target base current determiner 250 determines a target base current Ib based on the torque signal VT3 and the vehicle speed signal Vs. For example, as indicated by a graph of characteristic curves plotted in the block, the target base current Ib is of a larger value for generating a greater steering assisting force as the torque signal VT3 becomes greater and the vehicle speed signal Vs becomes smaller.

A target inertia correction current determiner 252 determines a target inertia compensation current Ii relative to an assistive steering force, for allowing the steering wheel 12 to start turning smoothly despite the influence of the moment of inertia of the electric motor 36, based on the vehicle speed signal Vs and the motor rotational speed signal Nm.

A target damping correction current determiner 254, which serves to cause a steering action to properly converge, determines a target damping correction current Id based on the vehicle speed signal Vs and the motor rotational speed signal Nm.

An adder 226 adds the target base current Ib, the target inertia compensation current Ii, and the target damping correction current Id into a final target current Ims. The difference calculator 1016 calculates the difference between the final target current signal Ims and an electric motor current signal Imo, which is detected by the current sensor (electric motor current detecting means, electric motor current detector) 1012, and outputs a difference signal ΔI representing the calculated difference. The PID compensator 1018 performs a PID control process for eliminating the difference signal ΔI.

More specifically, the PID compensator 1018 processes the difference signal ΔI, which represents the difference between the final target current signal Ims and the electric motor current signal Imo detected by the current sensor 1012 (see FIG. 2), according to the PID control process, and determines a motor drive voltage.

The PWM signal generator 1020 converts the motor drive voltage into a motor drive duty ratio, and outputs a PWM signal MCU (PWM/MCU) to an FET drive circuit (PWM drive circuit) 104 (see FIG. 2).

The FET drive circuit 104 converts the PWM signal MCU into a gate drive signal D, which matches the circuit configuration of a FET bridge circuit 106 next to the FET drive circuit 104, and supplies the gate drive signal D to the FET bridge circuit 106.

The FET bridge circuit 106 applies a motor drive voltage for supplying the final target current signal Ims to the electric motor 36.

The microcomputer 102 also detects failures in the sensors, the FET bridge circuit 106, the electric motor 36, and the microcomputer 102.

For example, if any of the wires interconnecting the signal generator 60 and the magnetostrictive torque sensor 44 is broken, or if the failure detector 62 detects a failure of a certain component of the magnetostrictive torque sensor 44, then one of the voltages VT3-1 and VT3-2, which is not associated with the failed component, is output as the torque signal VT3. Therefore, the electric power steering apparatus 10 is controlled continuously based on the torque signal VT3.

Since the microcomputer 102 obtains the failure detection signal (Fail) from the torque sensor circuit 100, the microcomputer 102 recognizes a failure of one system in the torque sensor circuit 100 and energizes a warning lamp 230. At this time, the microcomputer 102 may also warn the driver by reducing the target current signal Ims to a level lower than the normal value.

If the microcomputer 102 detects a failure of the current sensor 1012, then the microcomputer 102 changes from the current feedback control mode, which uses the output signal from the current sensor 1012, to a feed-forward control mode, which determines a motor drive current based on the output signal from the torque sensor circuit 100. At the same time, the microcomputer 102 energizes the warning lamp 230. The microcomputer 102 may also warn the driver by reducing the target current signal Ims to a level lower than the normal value.

The microcomputer 102 executes the following first, second, and third failure detecting processes.

The first failure detecting process is a watchdog timer monitoring process performed on the microcomputer 102 by the power supply circuit 120, which is a 5V power supply circuit. Normally, the microcomputer 102 periodically generates a watchdog timer signal WDT, which is monitored by the power supply circuit 120. If the power supply circuit 120 is not supplied with the watchdog timer signal WDT upon elapse of a prescribed period of time, then the power supply circuit 120 determines that the microcomputer 102 has failed. The power supply circuit 120 outputs an inhibit signal Sf through an OR gate 126 to the FET drive circuit 104 for causing the FET drive circuit 104 to not accept the PWM signal MCU from the microcomputer 102, or for inhibiting the FET drive circuit 104 from energizing the FETs of the FET bridge circuit 106. The power supply circuit 120 also outputs a resetting signal Rs to the microcomputer 102. If the microcomputer 102 is restored to a normal state by the resetting signal Rs, and the power supply circuit 120 confirms the watchdog timer signal WDT supplied thereto, then the power supply circuit 120 cancels the inhibit signal Sf output to the FET drive circuit 104, and returns the microcomputer 102 to a normal mode of operation.

If the microcomputer 102 is not restored to a normal state upon elapse of a prescribed period of time after the power supply circuit 120 has started to output the resetting signal Rs, then an auxiliary microcomputer 122 energizes the warning lamp 230, and a failure mode of the microcomputer 102, to be described later, is entered into.

The second failure detecting process is a watchdog timer monitoring process performed within the microcomputer 102 by a watchdog timer monitor 124. If the watchdog timer monitor 124 is not supplied with a watchdog timer signal WDT upon elapse of a prescribed period of time, then the watchdog timer monitor 124 determines that the microcomputer 102 has failed. The watchdog timer monitor 124 stops outputting the PWM signal MCU from the microcomputer 102, and generates a resetting signal. If the microcomputer 102 is restored to a normal state by the resetting signal and the watchdog timer monitor 124 confirms the watchdog timer signal WDT supplied thereto, then the watchdog timer monitor 124 returns the microcomputer 102 to the normal mode of operation. If the microcomputer 102 is not restored to a normal state upon elapse of a prescribed period of time after the watchdog timer monitor 124 has started to output the resetting signal, then the auxiliary microcomputer 122 energizes the warning lamp 230, and a failure mode of the microcomputer 102 is entered into.

The third failure detecting process is a monitoring process performed by the auxiliary microcomputer 122. The microcomputer 102 and the auxiliary microcomputer 122 calculate respective values from input signals, such as the torque signal VT3, and compare the calculated values with each other.

If the auxiliary microcomputer 122 detects a discrepancy between the compared values, then the auxiliary microcomputer 122 outputs an inhibit signal Sf through the OR gate 126 to the FET drive circuit 104, for causing the PWM signal MCU not to be accepted from the microcomputer 102, or for inhibiting the FET drive circuit 104 from energizing the FETs of the FET bridge circuit 106.

At this time, the auxiliary microcomputer 122 may output a stop signal to the power supply circuit 120, which then stops energizing the microcomputer 102 in order to disable the functions of the microcomputer 102. Then, in the auxiliary microcomputer 122, a failure mode of the microcomputer 102 is entered into.

If the microcomputer 102 detects a discrepancy between the compared values, then the microcomputer 102 energizes the warning lamp 230 and stops outputting the PWM signal MCU. Then, the microcomputer 102 enters the failure mode on its own.

When the microcomputer 102 is in a normal mode of operation, the electric power steering apparatus 10 is controlled in a current feedback control mode, during which the target current signal Ims is calculated. When the microcomputer 102 is in the failure mode, the electric power steering apparatus 10 is controlled in a feed-forward control mode (direct conversion control mode), during which the target current signal Ims is not calculated.

### Failure Mode of the Microcomputer 102:

The failure mode of the microcomputer 102 will be described below. When the microcomputer 102 is in a normal mode of operation, the microcomputer 102 generates a switch signal Sw, thereby turning on a transistor 130 in order to open a switch (switch means, gate means, gate element) 132, which comprises a normally closed semiconductor element such as a MOS FET or the like. As a result, a PWM signal TS generated by the PWM signal generator 66 of the torque sensor circuit 100 is prohibited from being input to the FED drive circuit 104.

In FIG. 2, for illustrative purposes, the PWM signal TS is illustrated as a single signal, which is transmitted over a single signal line. Actually, however, multiple PWM signals TS are transmitted over corresponding signal lines, which are equal in number to the number of arms of the FET bridge circuit 106. For example, if the electric motor 36 is a brush motor, then four PWM signals TS are required, which are transmitted over four corresponding signal lines.

If the microcomputer 102 suffers a failure or detects a failure in the auxiliary microcomputer 122, whereupon output of the PWM signal MCU is stopped, the switch signal Sw stops being generated, thereby turning off the transistor 130 to close the normally closed switch 132.

At this time, the PWM signal generator 66 directly converts the torque signal VT3 output from the torque sensor circuit 100 into the PWM signal TS, which is input via the switch 132 to the FET drive circuit 104. The FET drive circuit 104 causes the FET bridge circuit 106 to energize the electric motor 36, which generates an assistive steering force to assist the driver in turning the steering wheel 12.

In the event of a failure of the microcomputer 102, the relay drive circuit 140 causes a power relay 134 and a fail-safe relay 136 to remain closed, based on the relay signal Re output from the torque sensor circuit 100.

The FET drive circuit 104 converts the level of the PWM signal MCU or the PWM signal TS to a level that is high enough to turn the FETs of the FET bridge circuit 106 on and off. The FET drive circuit 104 outputs the level-converted gate drive signal D to the gates of the FETs. More specifically, PWM signals, i.e., the PWM signal MCU or the PWM signal TS, for the FETs at a lower potential and the FETs at a higher potential, have drive currents thereof increased by a buffer, with the gate drive signal D, which is elevated in voltage, being output to the FETs at the higher potential.

The FET drive circuit 104 has a function in an input state thereof for inhibiting the PWM signal MCU from the microcomputer 102 from being input to the FET drive circuit 104, in response to the inhibit signal Sf that is supplied from an external circuit, i.e., the auxiliary microcomputer 122 or the power supply circuit 120.

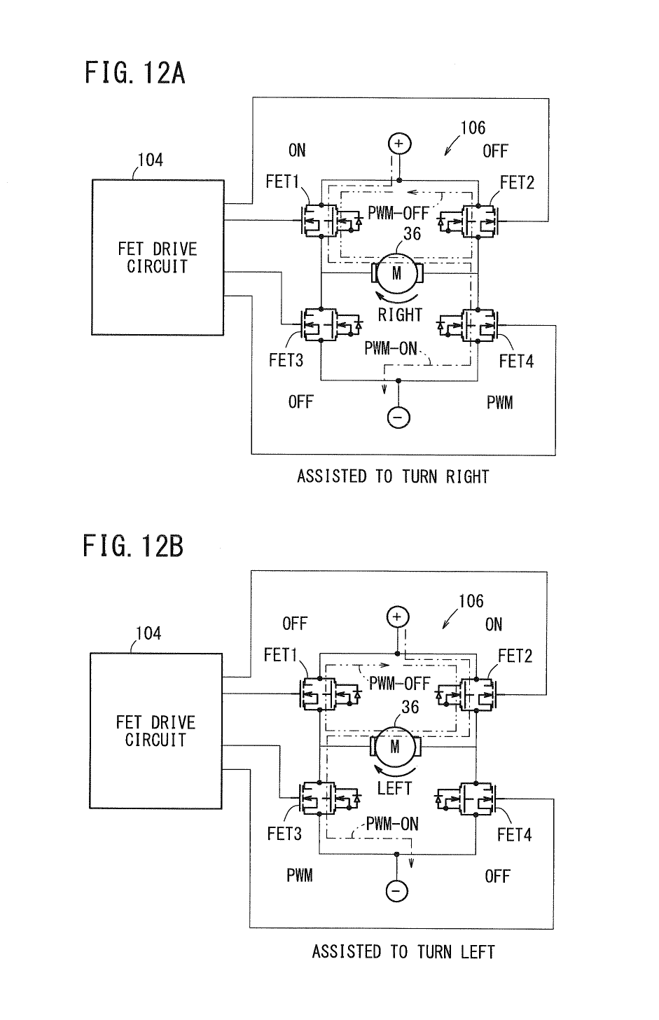

If the electric motor 36 is a DC brush motor, then the FET bridge circuit 106 has four FETs 1 through 4, each comprising a pair of parallel-connected FETs, for energizing the electric motor 36 under a PWM control, as shown in FIGS. 12A and 12B.

When the steering wheel 12 is assisted to turn to the right, as shown in FIG. 12A, the FET 1 is turned on and the FET 4 is energized under a PWM control. When the PWM signal, i.e., the PWM signal MCU or the PWM signal TS, is turned on, i.e., is made high in level, the FET 1 and the FET 4 are rendered conductive, thereby passing an electric current through the electric motor 36. When the PWM signal is turned off, i.e., is made low in level, an electric current continues to flow through the FET 1, the electric motor 36, and a reverse diode of the FET 2.

When the steering wheel 12 is assisted to turn to the left, as shown in FIG. 12B, the FET 2 is turned on and the FET 3 is energized under a PWM control. When the PWM signal, i.e., the PWM signal MCU or the PWM signal TS, is turned on, i.e., is made high in level, the FET 2 and the FET 3 are rendered conductive, thereby passing an electric current through the electric motor 36. When the PWM signal is turned off, i.e., is made low in level, an electric current continues to flow through the FET 2, the electric motor 36, and a reverse diode of the FET 1.

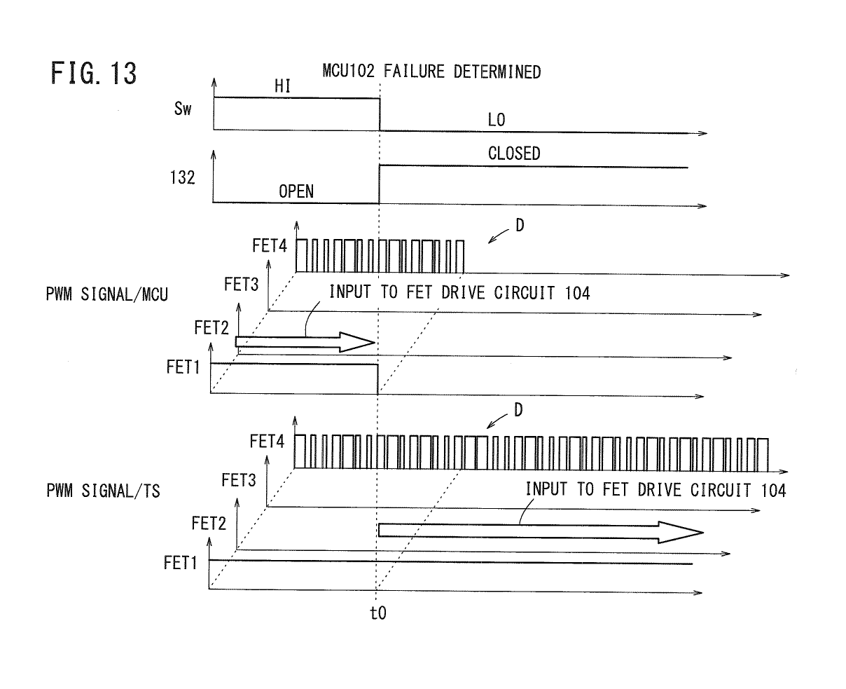

Instantaneous switching from the PWM signal MCU to the PWM signal TS in the event of a failure of the microcomputer 102, at a time the steering wheel 12 is assisted to turn to the right, will be described in detail below. FIG. 13 is a timing chart that illustrates switching between the PWM signals, i.e., from the PWM signal MCU to the PWM signal TS, in the event of a failure of the microcomputer 102. As shown in FIG. 13, when a failure of the microcomputer 102 is determined at time t0 (MCU102 FAILURE DETERMINED), the switch signal Sw changes from a high level to a low level, thereby turning off the transistor 130. The normally closed switch 132 changes from the open state to the closed state.

Prior to time t0, the gate drive signal D, which is associated with the PWM signal MCU output from the microcomputer 102, and the gate drive signal D, which is associated with the PWM signal TS output from the PWM signal generator 66 of the torque sensor circuit 100, are synchronized with a non-illustrated clock signal, and are output as drive signals for the FETs 1 through 4, i.e., a high-level drive signal for the FET 1, low-level drive signals for the FETs 2, 3, and a PWM signal for the FET 4. Prior to time t0, the gate drive signal D, which is associated with the PWM signal MCU output from the microcomputer 102, is output through the FET drive circuit 104 to the FET bridge circuit 106. At time t0, the gate drive signal D, which is associated with the PWM signal MCU, instantaneously switches to the gate drive signal D associated with the PWM signal TS. Subsequent to time t0, the gate drive signal D, which is associated with the PWM signal TS output from the PWM signal generator 66 of the torque sensor circuit 100, is output through the FET drive circuit 104 to the FET bridge circuit 106.

When the steering wheel 12 is assisted to turn to the left, the FETs 1 through 4 are driven as shown in FIG. 12B. At this time, the output gate drive signals D are the same as those described above with reference to FIG. 13, and will not be described in detail below.

If the electric motor 36 is a brushless DC motor, then the FET bridge circuit 106 comprises six FETs, i.e., three high-side FETs and three low-side FETs, making up a three-phase bridge circuit, which is driven under a PWM control.

If the electric motor 36 is a DC brush motor, then one current sensor 1012 is used, whereas if the electric motor 36 is a brushless DC motor, then two current sensors 1012 are used. Each of such current sensors 1012 outputs detected current values as an electric motor current signal Imo to the microcomputer 102.

If the electric motor 36 is a brushless DC motor, then the electric motor 36 is combined with a rotation sensor, such as a resolver or a hall sensor, for detecting an angular displacement of the rotor of the electric motor 36. The rotation sensor detects the angular displacement of the rotor, and outputs an angular displacement signal to the microcomputer 102. Based on the angular displacement signal and the electric motor current signal, the microcomputer 102 performs a d-q conversion process for performing a vector control of the electric motor 36.

If the electric motor 36 is a brushless DC motor, then the angular displacement signal may also be supplied to the PWM signal generator 66 of the torque sensor circuit 100, which generates the PWM signal TS based on the torque signal VT3 and the angular displacement signal. At this time, the magnitude (maximum duty ratio) of the PWM signal is established based on the torque signal VT3, and the phase of the PWM signal TS with respect to the rotor of the electric motor 36 is established based on the angular displacement signal. In the event of a failure of the microcomputer 102, the PWM signal TS is input through the switch 132 to the FET drive circuit 104, in the same manner as if the electric motor 36 were a brush motor.

The ECU 110 sends and receives a CAN (controller area network) signal (communication signal) for communications between intravehicular control devices, as well as electric power from the battery, a ground signal, a warning lamp signal, and the vehicle speed signal Vs from the vehicle speed sensor 222.

The transfer of functions of the electric power steering apparatus (EPS) 10 into a failure mode (subsequent to t0 in FIG. 13) of the microcomputer 102 is indicated by the CAN signal, which is transmitted to other intravehicular systems including a lane keeping system, a parking assisting system, and a vehicle stability assisting system, in order to inform these systems that some of the EPS functions are disabled. The other intravehicular systems then enter a degenerated mode.

### 2nd Embodiment

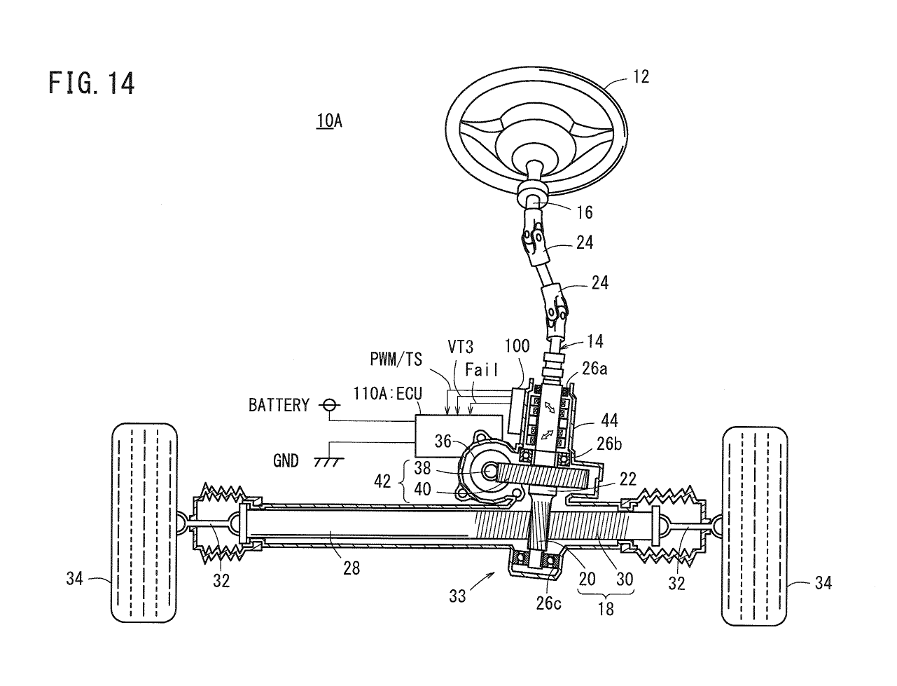

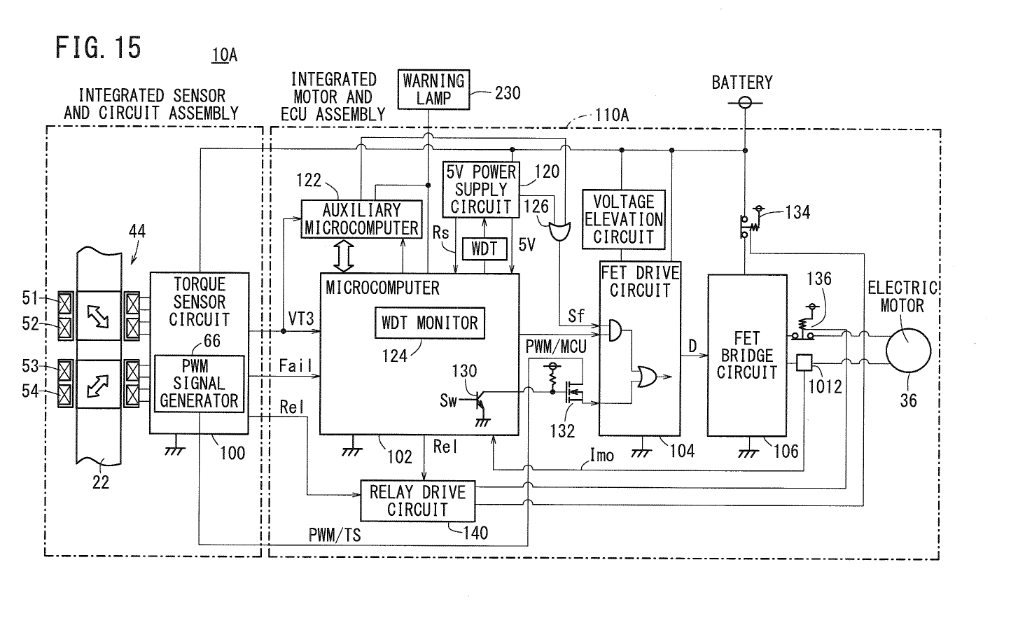

FIG. 14 schematically shows, partially in block form, an electric power steering apparatus 10A according to a second embodiment of the present invention. FIG. 15 shows in block form a circuit arrangement of the electric power steering apparatus 10A according to the second embodiment.

Those parts shown in FIGS. 14 and 15, which correspond to or are identical to those shown in FIGS. 1 and 2, are denoted by corresponding or identical reference characters, and such features will not be described in detail below.

As shown in FIGS. 14 and 15, a torque sensor circuit 100 does not comprise part of, but is located outside of, an ECU 110A, which is integrally combined with the electric motor 36. The torque sensor circuit 100 is integrally combined with the assembly of the coils 51 through 54 of the magnetostrictive torque sensor 44, and is housed in a casing made of a PPS resin, which is a functional resin that is highly resistant to heat and fire, and has excellent electrical properties. The coils 51 through 54 are electrically connected to the torque sensor circuit 100 by wires, which also are housed in the casing against exposure to the exterior.

As shown in FIG. 14, the ECU 110A, which is free of the torque sensor circuit 100, is housed in a casing, which is integrally molded with or fastened by screws to the case of the electric motor 36.

The ECU 110A and the electric motor 36 are electrically connected to each other by wires, including signal lines, power supply lines, and rotation sensor wires, which are housed in the casing against exposure to the exterior.

The electric power signal, the ground signal, the torque signal VT3, the failure detection signal (Fail), and the PWM signals, etc., are exchanged between the ECU 110A and the torque sensor circuit 100. The ECU 110A sends and receives the CAN signal, the electric power signal, the ground signal, the warning lamp signal, and the vehicle speed signal Vs.

### 3rd Embodiment

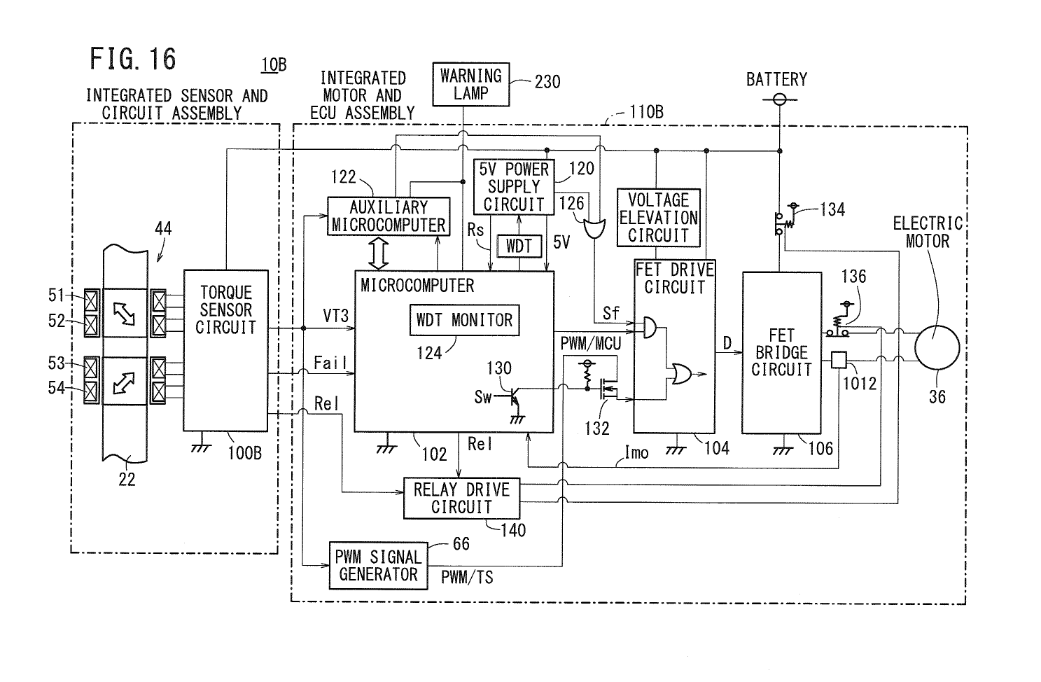

FIG. 16 shows in block diagram a circuit arrangement of an electric power steering apparatus 10B according to a third embodiment of the present invention.

Those parts shown in FIG. 16, which correspond to or are identical to those shown in FIGS. 2 and 15, are denoted by corresponding or identical reference characters, and such features will not be described in detail below.

As shown in FIG. 16, a PWM signal generator 66 for generating and outputting a PWM signal TS depending on the torque signal VT3 is located inside an ECU 110B, which is integrally combined with the electric motor 36. Accordingly, the number of components connected between a torque sensor circuit 100B, which is disposed outside the ECU 110B, and the ECU 110B is reduced.

As described above, each of the electric power steering apparatus 10, 10A, 10B according to the above-described embodiments includes the electric motor 36 for applying an assistive steering force to a steering system (i.e., the pinion shaft 22), the steering torque sensor (i.e., the magnetostrictive torque sensor 44 in the embodiments or a torsion-bar torque sensor) for detecting a steering torque of the steering system, the torque sensor circuit 100 for generating a steering torque signal VT3 based on the torque detected by the steering torque sensor, the first electric motor drive signal generator (i.e., the microcomputer 102) for generating a first electric motor drive signal (i.e., the PWM signal MCU as a first PWM signal) based on the steering torque signal VT3, and the electric motor driver (i.e., the series-connected circuit of the FET drive circuit 104 and the FET bridge circuit 106) for driving the electric motor 36 based on the first electric motor drive signal.

Each of the electric power steering apparatus 10, 10A, 10B also includes the second electric motor drive signal generator (i.e., the PWM signal generator 66, 66A) for directly converting the steering torque signal VT3 generated by the torque sensor circuit 100 into a second electric motor drive signal (i.e., the PWM signal TS as a second PWM signal, which changes depending on the magnitude of the steering torque signal VT3). In the event of a failure of the first electric motor drive signal generator (i.e., the microcomputer 102), the electric motor driver (i.e., the series-connected circuit of the FET drive circuit 104 and the FET bridge circuit 106) drives the electric motor 36 based on the second electric motor drive signal (i.e., the PWM signal TS), which is generated by the second electric motor drive signal generator (i.e., the PWM signal generator 66, 66A).

According to the above embodiments, in the event of a failure of the first electric motor drive signal generator (i.e., the microcomputer 102), which belongs to the main system, the electric motor driver (i.e., the series-connected circuit of the FET drive circuit 104 and the FET bridge circuit 106) drives the electric motor based on the second electric motor drive signal (i.e., the PWM signal TS), which is generated by the second electric motor drive signal generator (i.e., the PWM signal generator 66), which belongs to the redundant system, and which directly converts the steering torque signal VT3 generated by the torque sensor circuit 100 into the second electric motor drive signal (i.e., the PWM signal TS as a second PWM signal) that changes depending on the magnitude of the steering torque signal VT3, irrespective of the target current Ims supplied to the electric motor 36. Therefore, even in the event of a failure of the first electric motor drive signal generator (i.e., the microcomputer 102), which belongs to the main system, an assistive steering force depending on the steering torque can be applied to the steering system with a simple, small, and highly reliable arrangement, i.e., a less failure-prone arrangement, using the second electric motor drive signal generator (i.e., the PWM signal generator 66, 66A), which belongs to the simpler redundant system.

According to the above embodiments, furthermore, the PWM signal generator (second electric motor drive signal generator, second PWM signal generator) 66 or 66A, which generates the PWM signal TS (second electric motor drive signal, second PWM signal) for driving the electric motor 36 under a feed-forward control based on the steering torque signal VT3, is selectively connected by the switch 132 with respect to the microcomputer (first electric motor drive signal generator, first PWM signal generator) 102, for thereby generating the PWM signal MCU (first electric motor drive signal, first PWM signal) for driving the electric motor 36 under a feedback control based on the steering torque signal VT3.

In the event of a failure of the microcomputer (first electric motor drive signal generator, first PWM signal generator) 102, in the electric motor driver, i.e., the series-connected circuit made up of the FET drive circuit 104 and the FET bridge circuit 106, the switch 132 changes from the PWM signal MCU to the PWM signal TS (second electric motor drive signal, second PWM signal), which is generated by the PWM signal generator (second electric motor drive signal generator, second PWM signal generator) 66 or 66A, whereupon the electric motor 36 is driven by the PWM signal TS.

Since the PWM signal generator (second electric motor drive signal generator, second PWM signal generator) 66 or 66A directly converts the steering torque signal VT3 into the PWM signal TS (second electric motor drive signal, second PWM signal) for thereby carrying out the feed-forward control, it is not necessary to calculate the target current Ims. Therefore, the electronic power steering apparatus can be operated continuously with an arrangement that is simpler and more reliable than the microcomputer (first electric motor drive signal generator, first PWM signal generator) 102.

Although certain preferred embodiments of the present invention have been shown and described in detail, it should be understood that various changes and modifications may be made to the embodiments without departing from the scope of the invention as set forth in the appended claims.

What is claimed is:

1. An electric power steering apparatus comprising:
an electric motor for applying an assistive steering force to a steering system;
a steering torque sensor for detecting a steering torque of the steering system;
a torque sensor circuit for generating a steering torque signal based on the torque detected by the steering torque sensor;
a first electric motor drive signal generator for generating a first electric motor drive signal based on the steering torque signal;
an electric motor driver for driving the electric motor based on the first electric motor drive signal; and
a second electric motor drive signal generator for directly converting the steering torque signal generated by the torque sensor circuit into a second electric motor drive signal, which changes depending on the magnitude of the steering torque signal,
wherein, in the event of a failure of the first electric motor drive signal generator, the electric motor driver drives the electric motor based on the second electric motor drive signal, which is generated by the second electric motor drive signal generator.

2. The electric power steering apparatus according to claim 1, wherein the second electric motor drive signal generator directly converts the steering torque signal generated by the torque sensor circuit into a second electric motor drive signal, the second electric motor drive signal changing depending on the magnitude of the steering torque signal irrespective of a target current supplied to the electric motor.

3. The electric power steering apparatus according to claim 2, wherein the first electric motor drive signal generator generates the first electric motor drive signal for enabling the electric motor driver to drive the electric motor under a feedback control based on the steering torque signal; and
the second electric motor drive signal generator generates the second electric motor drive signal, which changes depending on the magnitude of the steering torque signal, for enabling the electric motor driver to drive the electric motor under a feed-forward control.

4. The electric power steering apparatus according to claim 1, wherein the first electric motor drive signal generator includes a microcomputer; and
the second electric motor drive signal generator comprises circuit components apart from a microcomputer.

5. The electric power steering apparatus according to claim 1, wherein the first electric motor drive signal generator and the second electric motor drive signal generator comprise a first microcomputer and a second microcomputer, respectively; and
the second microcomputer has a data processing capability for processing a smaller number of bits per unit time than the first microcomputer.

6. The electric power steering apparatus according to claim 1, wherein the first electric motor drive signal generator generates the first electric motor drive signal based on a vehicle speed signal in addition to the steering torque signal; and
the second electric motor drive signal generator generates the second electric motor drive signal based only on the steering torque signal.

7. The electric power steering apparatus according to claim 1, wherein the torque sensor circuit includes a plurality of torque sensor circuits, and in the event of a failure of one of the torque sensor circuits, the remaining torque sensor circuits are used to detect a steering torque of the steering system.

8. The electric power steering apparatus according to claim 1, wherein the second electric motor drive signal generator operates prior to the first electric motor drive signal generator suffering a failure; and
when the first electric motor drive signal generator suffers a failure, the first electric motor drive signal instantaneously switches to the second electric motor drive signal, which is generated by the second electric motor drive signal generator.

9. The electric power steering apparatus according to claim 1, wherein each of the first electric motor drive signal and the second electric motor drive signal comprises a PWM signal.

10. The electric power steering apparatus according to claim 1, wherein the steering torque sensor comprises a magnetostrictive torque sensor for detecting the steering torque of the steering system based on a change in the magnetic permeability thereof.
